(19) United States
(12) Patent Application Publication
(10) Pub. No.: US 2015/0125127 A1
(43) Pub. Date: May 7, 2015

(54) VIDEO PLAYING SYSTEM AND METHOD OF USING SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIA-HUNG CHIEN, New Taipei (TW); TSUNG-JEN CHUANG, New Taipei (TW); JUN ZHANG, Shenzhen (CN)

(21) Appl. No.: 14/533,101

(22) Filed: Nov. 5, 2014

(30) Foreign Application Priority Data
Nov. 5, 2013 (CN) 201310540282.X

(51) Int. Cl. G11B 27/19; G11B 27/10; H04N 5/765; H04N 5/91; G11B 33/10

(52) U.S. Cl. CPC G11B 27/19; H04N 5/91; G11B 33/10; H04N 5/765; G11B 27/102
USPC 386/230; 386/241

(57) ABSTRACT

A system and method used in an electronic apparatus for playing a video stored in the electronic apparatus via a display. The video playing system splits the video into a number of video segments. Each of the video segments has predetermined time duration. The video playing system analyzes each video segment to acquire image backgrounds and facial features of the video segments and delete a latter video segment of two adjacent video segments when the image backgrounds and the facial features of the latter video segment of two adjacent video segments is the same as the image backgrounds and the facial features of an earlier video segment of two adjacent video segments.

### 1. TECHNICAL FIELD

The disclosure generally relates to video playing technologies, and particularly to a video playing system and method for an electronic apparatus.

### 2. DESCRIPTION OF RELATED ART

Many electronic apparatus, such as cellular phones, consume a lot of electrical power while playing video. A battery level indicator is used to represent a remaining electrical power of the electronic apparatus. The battery level value of the electronic apparatus may decrease quickly when the electronic apparatus is playing video. However, a performance of video playing is somehow comprised when the electronic apparatus is run at a low battery level condition.

Therefore, it is desirable to provide a means which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic apparatus including a video playing system.

FIG. 2 is a flowchart of one embodiment of a video playing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Reference will be made to the drawings to describe various embodiments.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

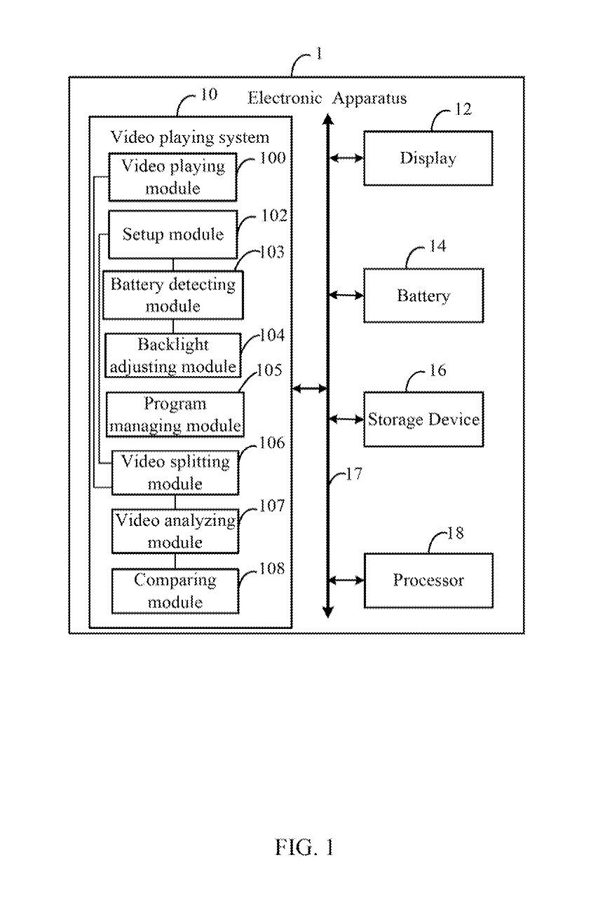

FIG. 1 is a block diagram of one embodiment of an electronic device 1 including a video playing system 10. The electronic device 1 further includes a display 12, a battery 14, a storage device 16, and a processor 18. The battery 14 provides power to electrical components of the electronic apparatus 1. The storage device 16 stores an operating system of the electronic apparatus 1 and media data, such as videos, pictures, and soundtracks. The operating system is executed by the processor 18. The display 12, the storage device 16, the battery 14, and a processor 18 are directly or indirectly electrically connected via a bus 17 for exchange of data or control signals.

The video playing system 10 can be a subsystem of the operating system. The video playing system 10 also can be a system independent from the operating system, stored in the storage device 16 or embedded in a firmware. The electronic device 1 may be, but is not limited to, a smart phone, a tablet computer, a notebook, an electronic book, or a portable game machine.

The video playing system 10 includes a video playing module 100, a setup module 102, a battery detecting module 103, a backlight adjusting module 104, a program managing module 105, a video splitting module 106, a video analyzing module 107, and a comparing module 108. These modules 100-107 of the video playing system 10 are directly or indirectly connected with each other to exchange data or control signals.

The setup module 102 is used to preset a number of working values of the video playing system 10. The working value may be, but is not limited to, a predetermined time interval to detect a battery level value of the electronic apparatus, a predetermined threshold battery level value, a predetermined time duration of a video segment, and a number of predetermined correspondences between the battery level value of the electronic apparatus 1 and the backlight brightness of the display 12. In this embodiment, the predetermined correspondences between the battery level value of the electronic apparatus 1 and the backlight brightness of the display 12 may be, but is not limited to, the backlight brightness of the display 12 is eighty percent of a maximum backlight brightness of the display 12 when the battery level value of the electronic apparatus 1 is more than about sixty percent of the maximum battery level value of the electronic apparatus 1 and not more than about eighty percent of the maximum battery level value of the electronic apparatus 1, the backlight brightness of the display 12 is sixty percent of the maximum backlight brightness of the display 12 when the battery level value of the electronic apparatus 1 is more than about fifty percent of the maximum backlight brightness of the display 12 and not more than about sixty percent of the maximum backlight brightness of the display 12, and the backlight brightness of the display 12 is fifty percent of the maximum backlight brightness of the display 12 when the battery level value of the electronic apparatus 1 is not more than fifty percent of the maximum backlight brightness of the display 12.

The video playing module 100 plays the video stored in the storage device 16.

The battery detecting module 103 reads the battery level value of the electronic apparatus 1 from the battery 14 in the predetermined time interval. The battery detecting module 103 transmits the battery level value of the electronic apparatus 1 to the backlight adjusting module 10. The battery detecting module 103 correspondingly transmits a low power signal the program managing module 105 and the video splitting module 106 when the battery level value of the electronic apparatus 1 is less than the predetermined threshold battery level value. In this embodiment, the predetermined threshold battery level value is fifty percent of a maximum battery level value of the electronic apparatus 1.

The program managing module 105 reminds a user to shut down a number of background programs irrelevant to playing the video when the program managing module 105 receives the low power signal from the battery detecting module 103. In detail, the program managing module 105 displays a pop-up window to show a list of the background programs irrelevant to playing the video. The user can select to shut down the background programs on the list.

The backlight adjusting module 104 adjusts a backlight brightness of the display 12 according to the battery level value of the electronic apparatus 1 and the predetermined correspondences between the battery level value of the electronic apparatus 1 and the backlight brightness of the display 12.

The video splitting module 106 splits the part of the video that has not been played into a number of video segments when it receives the low power signal from the battery detecting module 103. Each of the video segments has the same predetermined time duration. For example, if a frame rate of the video is twenty-four frames per second, the predetermined time duration can be set as one twenty-fourth second.

The video analyzing module 107 executes an image analysis to each of the video segments to acquire image backgrounds and facial features of the video segments. The video analyzing module 107 employs a number of graphics algorithms to statistically analyze colors and gray scales of a number of pixels constituting the images of each video segment in order to acquire the image background and facial features of the video segments. The graphic algorithms may be, but are not limited to, an edge filtering algorithm, a Hough transform algorithm, and a face recognition algorithm.

The comparing module 108 compares the image backgrounds and facial features of each two adjacent video segments from a first video segment to a last video segment of the rest of the video that has not been played. The comparing module 108 assigns a skip tag to a latter video segment of the two adjacent video segments when the image backgrounds and facial features of these two adjacent video segments are the same as each other. The video playing module 100 skips the video segments with the skip tag when plays the rest part of the video that has not been played.

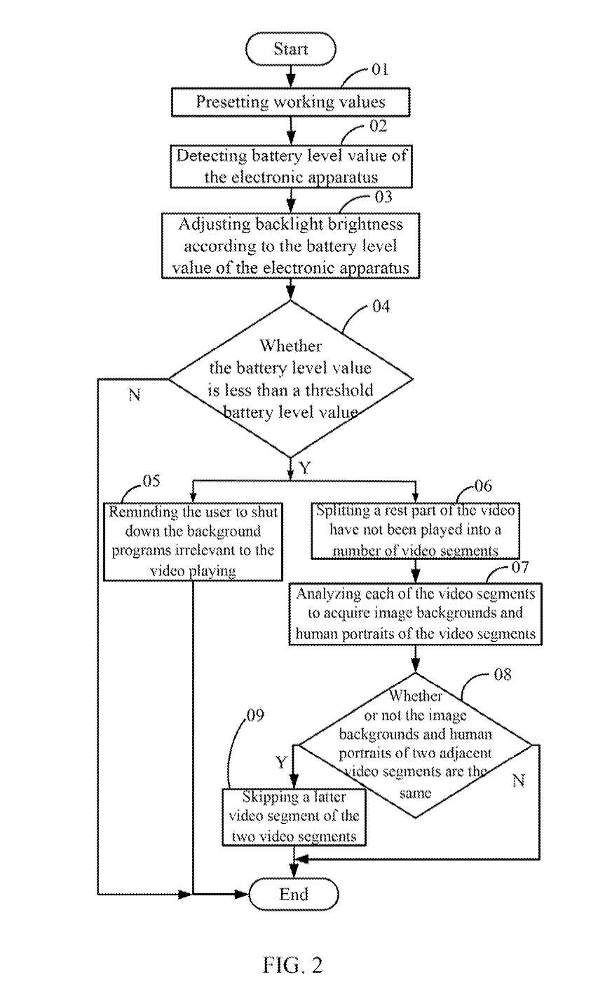

Referring to FIG. 2, a flowchart is presented in accordance with an example embodiment which is being thus illustrated. The example method is provided by way of example, as there are a variety of ways to carry out the method. The method described below can be carried out using the configurations illustrated in FIG. 1, for example, and various elements of these figures are referenced in explaining example method. Each block shown in FIG. 2 represents one or more processes, methods or subroutines, carried out in the exemplary method. Additionally, the illustrated order of blocks is by example only and the order of the blocks can change according to the present disclosure. The exemplary method 300 can begin at block 01.

At block 01, a number of working values of the video playing system 10 are preset via the setup module 102. The working value may be, but is not limited to, a predetermined time interval to detect the battery level value of the electronic apparatus, a predetermined threshold battery level value, a predetermined time duration of a video segment, and a number of predetermined correspondences between the battery level value of the electronic apparatus 1 and the backlight brightness of the display 12.

In this embodiment, the predetermined correspondence between the battery level value of the electronic apparatus 1 and the backlight brightness of the display 12 may be, but are not limited to, the backlight brightness of the display 12 is eighty percent of a maximum backlight brightness of the display 12 when the battery level value of the electronic apparatus 1 is more than about sixty percent of the maximum battery level value of the electronic apparatus 1 and not more than about eighty percent of the maximum battery level value of the electronic apparatus 1, the backlight brightness of the display 12 is sixty percent of the maximum backlight brightness of the display 12 when the battery level value of the electronic apparatus 1 is more than about fifty percent of the maximum backlight brightness of the display 12 and not more than about sixty percent of the maximum backlight brightness of the display 12, and the backlight brightness of the display 12 is fifty percent of the maximum backlight brightness of the display 12 when the battery level value of the electronic apparatus 1 is not more than fifty percent of the maximum backlight brightness of the display 12.

At block 02, the battery detecting module 103 reads the battery level value of the electronic apparatus 1 from the battery 14 in the predetermined time interval. The battery detecting module 103 transmits the battery level value of the electronic apparatus 1 to the backlight adjusting module 10.

At block 03, the backlight adjusting module 104 adjusts a backlight brightness of the display 12 according to the battery level value of the electronic apparatus 1 and the predetermined correspondences between the battery level value of the electronic apparatus 1 and the backlight brightness of the display 12.

At block 04, the battery detecting module 103 correspondingly transmits a low power signal to the program managing module 105 and the video splitting module 106 when the battery level value of the electronic apparatus 1 is less than the predetermined threshold battery level value.

At block 05, the program managing module 105 reminds the user to shut down the background programs irrelevant to playing the video when the program managing module 105 receives the low power signal from the battery detecting module 103.

In detail, a pop-up window is displayed to show a list of the background programs irrelevant to playing the video. The user can select to shut down the background programs on the list.

At block 06, the video splitting module 106 splits the part of the video that has not been played into a number of video segments when it receives the low power signal from the battery detecting module 103. Each of the video segments has the same predetermined time duration. For example, if a frame rate of the video is twenty-four frames per second, the predetermined time duration can be set as one twenty-fourth second.

At block 07, the video analyzing module 107 analyzes each of the video segments to acquire image backgrounds and facial features of the video segments.

In detail, the video analyzing module 107 employs a number of graphics algorithms to statistically analyze colors and gray scales of a number of pixels constituting the images of each video segment in order to acquire the image background and facial features of the video segments. The graphic algorithms may be, but are not limited to, an edge filtering algorithm, a Hough transform algorithm, and a face recognition algorithm.

At block 08, the comparing module 108 compares the image backgrounds and facial features of each two adjacent video segments start from a first video segment of the rest of the video that has not been played. The comparing module 108 assigns a skip tag to a latter video segment of the two adjacent video segments when the image backgrounds and facial features of these two adjacent video segments are the same with each other.

At block 09, the video playing module 100 skips the video segments with the skip tag when plays the rest of the video that has not been played.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A video playing system of an electronic apparatus, the system comprising:
a video playing module configured to play a video;
a setup module configured to set a predetermined time duration;
a video splitting module configured to subdivide an unplayed portion of the video into a plurality of segments, each of the segments having the same predetermined time duration;
a video analyzing module configured to analyze each of the segments to acquire image backgrounds and facial features therefrom; and
a comparing module configured to compare the image backgrounds and facial features of each of two adjacent segments from a first segment to a last segment of the unplayed portion of the video;
wherein the comparing module is configured to control the video playing module to skip a latter segment of the two adjacent segments when the image backgrounds and facial features of these two adjacent segments are the same with each other.

2. The video playing system of claim 1, wherein the setup module further presets a predetermined time interval to detect a battery level value of the electronic apparatus and a plurality of predetermined correspondences between the battery level value of the electronic apparatus and the backlight brightness of the electronic apparatus.

3. The video playing system of claim 2, further comprising:
a battery detecting module that reads the battery level value of the electronic apparatus in the predetermined time interval; and
a backlight adjusting module adjusts a backlight brightness of the display according to the battery level value of the electronic apparatus and the predetermined correspondences between the battery level value of the electronic apparatus and the backlight brightness of the electronic apparatus.

4. The video playing system of claim 3, wherein the predetermined correspondences between the battery level value of the electronic apparatus and the backlight brightness of the electronic apparatus comprises the backlight brightness of the electronic apparatus is eighty percent of a maximum backlight brightness of the electronic apparatus when the battery level value of the electronic apparatus is more than about sixty percent of the maximum battery level value of the electronic apparatus and not more than about eighty percent of the maximum battery level value of the electronic apparatus, the backlight brightness of the electronic apparatus is sixty percent of the maximum backlight brightness of the electronic apparatus when the battery level value of the electronic apparatus is more than about fifty percent of the maximum backlight brightness of the electronic apparatus and not more than about sixty percent of the maximum backlight brightness of the electronic apparatus, and the backlight brightness of the electronic apparatus is fifty percent of the maximum backlight brightness of the electronic apparatus when the battery level value of the electronic apparatus is not more than fifty percent of the maximum backlight brightness of the electronic apparatus.

5. The video playing system of claim 3, further comprising:
a program managing module that reminds a user to shut down a plurality of background programs irrelevant to playing the video when the battery level value of the electronic apparatus is below a predetermined threshold battery level value.

6. The video playing system of claim 5, wherein the setup module further presets a predetermined threshold battery level value, the battery detecting module transmits a low power signal to the program managing module, and the program managing module displays a pop-up window to show a list of the background programs irrelevant to playing the video when receives the low power signal.

7. The video playing system of claim 1, wherein the video analyzing module employs an edge filtering algorithm, a Hough transform algorithm, and a face recognition algorithm to statistically analyze colors and gray scales of a plurality of pixels constituted of the images of each segment in order to acquire the image background and facial features of the segments.

8. The video playing system of claim 1, wherein the video playing system is embedded in a firmware of the storage device.

9. A video playing method for playing a video stored in an electronic apparatus, the method comprising:
presetting a predetermined time duration;
splitting an unplayed portion of the video into a plurality of segments, each of the segments having the same predetermined time duration;
analyzing each of the segments to acquire image backgrounds and facial features of the segments;
comparing the image backgrounds and facial features of each of two adjacent segments from a first segment to a last segment of the rest part of the have not been played; and
skipping a latter segment of the two adjacent segments when plays the rest part of the video have not been played if the image backgrounds and facial features of these two adjacent segments are the same as each other.

10. The method of claim 9, before the step of splitting a rest part of the video that has not been played into a plurality of video segments, further comprising:
presetting a predetermined threshold battery level value;
detecting a battery level value of the electronic apparatus 1;
executing the step of splitting an unplayed portion of the video that has not been played into a plurality of segments when the battery level value of the electronic apparatus is less than the predetermined threshold battery level value.

11. The method of claim 10, further comprising:
reminding a user to shut down the background programs irrelevant to playing the video when the battery level value of the electronic apparatus is less than the predetermined threshold battery level value.

12. The method of claim 9, further comprising:
presetting a predetermined time interval to detect a battery level value of the electronic apparatus and a plurality of predetermined correspondences between the battery level value of the electronic apparatus and the backlight brightness of electronic apparatus;
detecting the battery level value of the electronic apparatus in the predetermined time interval; and
adjusting the backlight brightness of electronic apparatus according to the battery level value of the electronic apparatus and the predetermined correspondences between the battery level value of the electronic apparatus and the backlight brightness of the display.

13. The method of claim 12, wherein the predetermined correspondences between the battery level value of the electronic apparatus and the backlight brightness of the display comprises the backlight brightness of the display is eighty percent of a maximum backlight brightness of the display when the battery level value of the electronic apparatus is more than about sixty percent of the maximum battery level value of the electronic apparatus and not more than about eighty percent of the maximum battery level value of the electronic apparatus, the backlight brightness of the display is sixty percent of the maximum backlight brightness of the display when the battery level value of the electronic apparatus is more than about fifty percent of the maximum backlight brightness of the display and not more than about sixty percent of the maximum backlight brightness of the display, and the backlight brightness of the display is fifty percent of the maximum backlight brightness of the display when the battery level value of the electronic apparatus is not more than fifty percent of the maximum backlight brightness of the display.

14. The method of claim 9, wherein an edge filtering algorithm, a Hough transform algorithm, and a face recognition algorithm are employed to statistically analyze colors and gray scales of a plurality of pixels constituted of the images of each video segment in order to acquire the image background and facial features of the video segments.
